(19) United States
(12) Patent Application Publication
(10) Pub. No.: US 2026/0040113 A1
(43) Pub. Date: Feb. 5, 2026

(54) METHODS, ARCHITECTURES, APPARATUSES AND SYSTEMS FOR MOBILITY REPORTING

(71) Applicant: InterDigital Patent Holdings, Inc., Wilmington, DE (US)

(72) Inventors: Brian Martin, Farnham (GB); Martino Freda, Laval (CA); Dylan Watts, Montreal (CA); Oumer Teyeb, Montreal (CA); Keiichi Kubota, Setagaya-Ku (JP); Paul Marinier, Brossard (CA); Afshin Haghighat, Ile-Bizard (CA); Jonghyun Park, Syosset, NY (US)

(21) Appl. No.: 18/794,477

(22) Filed: Aug. 5, 2024

(51) Int. Cl. H04W 24/10; H04B 7/0413

(52) U.S. Cl. CPC H04W 24/10; H04B 7/0413

(57) ABSTRACT

Procedures, methods, architectures, apparatuses, systems, devices, and computer program products for reporting of measurement events in a wireless communication network. A wireless transmit-receive unit may receive configuration information for reporting different types of measurement events. It may determine to report a first type of measurement event in a specific report of a first type but may lack uplink resources to do so. It may have resources to transmit a second type of report. It may send an indication of the first type of measurement event using the resources for transmitting the second type of report and include an indication that resources for transmitting the report of the first type are requested. Having received resource availability confirmation, it transmits the first type report with measurement results of the first type. This allows the WTRU to efficiently manage and report various measurement events based on resource availability and type of report required.

### INCORPORATION BY REFERENCE

The following documents are incorporated by reference in their entirety: RP-234036: 3GPP TSG RAN Meeting #102: “New WID: NR Mobility Enhancements phase 4”, Dec. 11-15, 2023; 3GPP TS 38.300 v18.1.0 (Release 18) “Technical Specification Group Radio Access Network; NR; NR and NG-RAN Overall Description; Stage 2”, December 2023; RP-240087: 3GPP TSG RAN Meeting #104: “WID Revision: NR MIMO Phase 5”, Mar. 18-21, 2024.

### BACKGROUND

The present disclosure is generally directed to the fields of communications, software and encoding, including, for example, to methods, architectures, apparatuses, systems related to radio communications in wireless networks.

### SUMMARY

There are disclosed embodiments of methods, as described in the following and as claimed in the appended claims.

There are disclosed embodiments of a device, as described in the following and as claimed in the appended claims.

### BRIEF DESCRIPTION OF THE DRAWINGS

A more detailed understanding may be had from the detailed description below, given by way of example in conjunction with drawings appended hereto. Figures in such drawings, like the detailed description, are examples. As such, the Figures (FIGS.) and the detailed description are not to be considered limiting, and other equally effective examples are possible and likely. Furthermore, like reference numerals (“ref.”) in the FIGS. indicate like elements, and wherein:

FIG. 1A is a system diagram illustrating an example communications system;

FIG. 1B is a system diagram illustrating an example wireless transmit/receive unit (WTRU) that may be used within the communications system illustrated in FIG. 1A;

FIG. 1C is a system diagram illustrating an example radio access network (RAN) and an example core network (CN) that may be used within the communications system illustrated in FIG. 1A;

FIG. 1D is a system diagram illustrating a further example RAN and a further example CN that may be used within the communications system illustrated in FIG. 1A;

FIG. 2 is a legacy Rel. 18 LTM procedure;

FIG. 3 is an embodiment of a method for reporting mobility measurement results; and

FIG. 4 is an embodiment of a method for reporting mobility measurement results with L1 measurement event evaluation interaction.

FIG. 5 is a flow chart of a method for reporting mobility measurement results according to an embodiment.

### DETAILED DESCRIPTION

### Abbreviations and Acronyms

ARQ Automatic Repeat Request
BFD Beam Failure Detection
BFR Beam Failure Recovery
BSR Buffer Status Report
BM Beam
BWP Bandwidth Part
CA Carrier Aggregation
CBRA Contention-Based Random Access
CFRA Contention-Free Random Access
CHO Conditional Handover
CORESET Control Resource Set
CPA Conditional PSCell Addition
CPC Conditional PSCell Change
CQI Channel Quality Index
CRI CSI-RS Resource Indicator
CSI Channel State Information
CSI-RS CSI-Reference Signal
CU Centralized Unit
DC Dual Connectivity
DCI Downlink Control Information
DL Downlink
DM Demodulation
DM(-)RS DM Reference Signal
DPCCH Dedicated Physical Control Channel
DPSCH Dedicated Physical Shared Channel
DU Distributed Unit
FFS For Further Study
FR1, FR2 Frequency Range 1, 2
HARQ Hybrid Automatic Repeat Request
HOF Handover Failure
ID Identifier
L1, L2, L3 Layer-1, Layer-2, Layer-3
LBT Listen Before Talk
LI Layer Indicator
LTM Layer 1 (/L2) Triggered Mobility/Lower-Layer Triggered Mobility
NR New Radio
NTN Non-Terrestrial Network
NW Network
MAC Medium Access Control
MAC-CE MAC Control Element
MCS Modulation Coding Scheme
MIB Master Information Block
MIMO Multiple Input Multiple Output
MN Master Node
OD On-Demand
PBCH Physical Broadcast Channel
PCell Primary Cell
PMI Precoding Matrix Index
PDCCH Physical DL Control Channel
PDCP Packet Data Convergence Protocol
PDSCH Physical DL Shared Channel
PMI Precoding Matrix Indicator
PRACH Physical Random-Access Channel
PSCell Primary and Secondary Cells
PSS Primary Synchronization Signal
PUCCH Physical UL Control Channel
PUSCH Physical UL Shared Channel
QCL Quasi-Colocation
QCL-D QCL type D
QCLed Quasi-Colocated
QoS Quality of Service
RACH Random Access Channel
RAR Random Access Response
RAT Radio Access Technology
Rel Release (e.g., of 3GPP specification)
RI Rank Indicator
RIS Reconfigurable Intelligent Metasurface
RLC Radio Link Control
RLF Radio Link Failure
RLM Radio Link Monitoring
RRC Radio Resource Control
RRM Radio Resource Management
RS Reference Signal(s)
RSRP Reference Signal Received Power
RSRQ Reference Signal Received Quality
RSSI Received Signal Strength Indicator
Rx Receive(r)
SCell Secondary Cell
SCG Secondary Cell Group
SFI Slot Format Indicator
SFN System Frame Number
SIB System Information Block
SINR Signal-to-Interference and Noise Ratio
SN Secondary Node
SpCell Special Cell
SR Scheduling Request
SRS Sounding Reference Signal
SS Synchronization Signal
SSB SS Block
SSBRI SS/PBCH Block Resource Indicator
SSS Secondary Synchronization Signal
TA Timing Advance
TCI Transmission Synchronization Indicator
TRP Transmission/Reception Point
TTT Time To Trigger
Tx Transmit(ter)
UCI UL Control Information
UE User Equipment (see WTRU)
UL Uplink
WUS Wake-Up Signal
WTRU Wireless Transmit-Receive Unit (see UE)

### Terminology, Principles and Observations

### [LTM] (Layer 1 (L1)/L2 Based Mobility, Also Known as Lower Layer Triggered Mobility)

Handover is the process of transferring a communication session from one cell to another to maintain seamless connectivity, especially during movement. There are two types of mobility: beam level and cell level. Beam level mobility does not require explicit RRC signaling and is controlled at lower layers, while cell level mobility requires explicit RRC signaling. NR supports different handover types, including basic handover from LTE. In NR high frequency range with beamforming, signal degradation may occur when a WTRU moves, leading to potential handover failures. Conditional Handover (CHO) improves handover reliability by executing only when specific conditions are met. The WTRU maintains connection with the source gNB, evaluates CHO candidate cells, and executes CHO by detaching from the source gNB and accessing the target cell if conditions are satisfied. Overall, handover in NR ensures continued service for users, with mechanisms like beam level and cell level mobility and CHO enhancing the effectiveness and reliability of the handover process.

LTM is a procedure in which a gNB receives L1 measurement report(s) from a WTRU, and on their basis the gNB changes WTRU serving cell by a cell switch command signaled via a MAC CE. The cell switch command indicates an LTM candidate configuration that the gNB previously prepared and provided to the WTRU through RRC signalling. Then the WTRU switches to the target configuration according to the cell switch command. The LTM procedure can be used to reduce the mobility latency.

When configured by the network, it is possible to activate TCI states of one or multiple cells that are different from the current serving cell. For instance, the TCI states of the LTM candidate cells can be activated in advance before any of those cells become the serving cell. This allows the WTRU to be DL synchronized with those cells, thereby facilitating a faster cell switch to one of those cells when cell switch is triggered.

When configured by the network, it is possible to initiate UL TA acquisition (called early TA) procedure of one or multiple cells that are different from the current serving cells. If the cell has the same N_{TA} as the current serving cells or N_{TA}=0, early TA acquisition procedure is not required. The network may request the WTRU to perform early TA acquisition of a candidate cell before a cell switch. The early TA acquisition procedure is triggered by PDCCH order or realized through WTRU-based TA measurement as configured by RRC. In the former case, the gNB to which the candidate cell belongs calculates the TA value and sends it to the gNB to which the serving cell belongs. The serving cell sends the TA value in the LTM cell switch command MAC CE when triggering LTM cell switch. In the latter case, the WTRU performs TA measurement for the candidate cells after being configured by RRC but the exact time the WTRU performs TA measurement is up to WTRU implementation. The WTRU applies the TA value measured by itself and performs RACH-less LTM upon receiving the cell switch command. The network may also send a TA value in the LTM cell switch command MAC CE without early TA acquisition.

Depending on the availability of a valid TA value, the WTRU performs either a RACHless LTM or RACH-based LTM cell switch. If the TA value is provided in the cell switch command, the WTRU applies the TA value as instructed by the network. In the case where WTRU-based TA measurement is configured, but no TA value is provided in the cell switch command, the WTRU applies the TA value by itself if available. Meanwhile, the WTRU performs RACH-less LTM cell switch upon receiving the cell switch command. If no valid TA value is available, the WTRU performs RACH-based LTM cell switch.

Regardless of whether the WTRU is configured for WTRU-based TA measurement for a certain candidate cell, it will still follow the PDCCH order, which includes requesting a random access procedure towards the candidate cells. This also applies to the candidate cells for which the WTRU is capable of deriving TA values by itself. Additionally, regardless of whether the WTRU has already performed a random access procedure towards the candidate cells, it will still follow the WTRU-based measurement configuration if configured by the network.

For RACH-less LTM, the WTRU accesses the target cell using either a configured grant or a dynamic grant. The configured grant is provided in the LTM candidate configuration, and the WTRU selects the configured grant occasion associated with the beam indicated in the cell switch command. Upon initiation of LTM cell switch to the target cell, the WTRU starts to monitor PDCCH on the target cell for dynamic scheduling. Before RACH-less LTM procedure completion, the WTRU shall not trigger random access procedure if it does not have a valid PUCCH resource for triggered SRs.

The following principles apply to LTM:
Security key is maintained upon an LTM cell switch;
Subsequent LTM is supported.

LTM supports both intra-gNB-DU and intra-gNB-CU inter-gNB-DU mobility. LTM supports both intra-frequency and inter-frequency mobility, including mobility to inter-frequency cell that is not a current serving cell. LTM is supported only for licensed spectrum. The following scenarios are supported:
PCell change in non-CA scenario and non-DC scenario;
PCell and SCell(s) change in CA scenario;

Dual connectivity scenario, PCell and MCG SCell(s) change and intra-SN PSCell and SCG SCell(s) change without MN involvement. LTM for simultaneous PCell and PSCell change is not supported.

While the WTRU has stored LTM candidate configurations the WTRU can also execute any L3 handover command sent by the network.

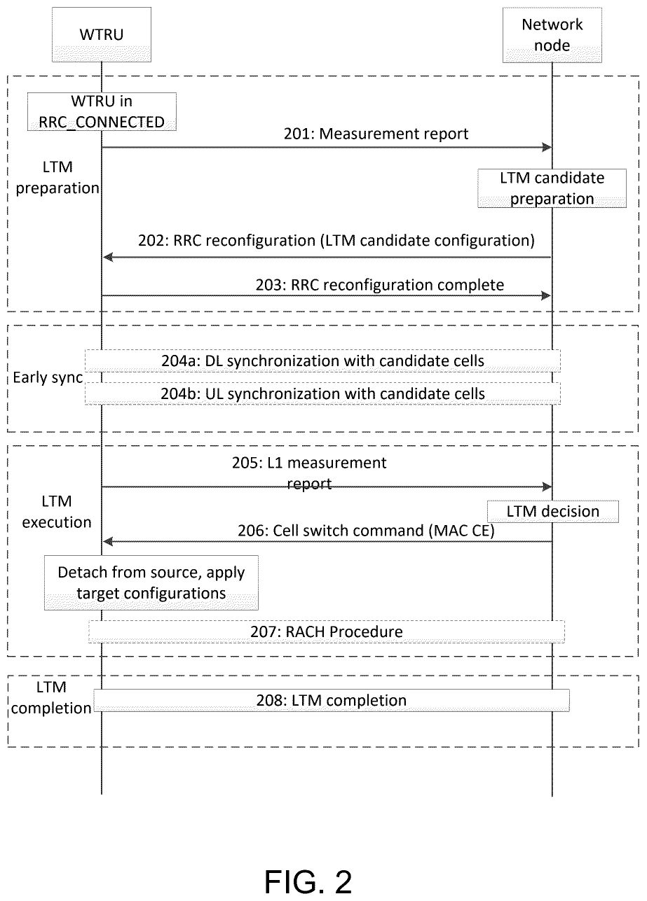

The Rel-18 procedure is defined in FIG. 2.

In 201, the WTRU sends a MeasurementReport message to the gNB. The gNB decides to use LTM and initiates LTM candidate preparation.

In 202, the gNB transmits an RRCReconfiguration message to the WTRU including the configuration of one or multiple LTM candidate target cells.

In 203, the WTRU stores the configuration of LTM candidate target cell(s) and transmits a RRCReconfigurationComplete message to the gNB.

In 204a/204b, the WTRU may perform downlink (DL) synchronization and timing advance (TA) acquisition with candidate target cell(s) before receiving the LTM cell switch command.

In 205, the WTRU performs L1 measurements on the configured LTM candidate target cell(s), and transmits lower-layer measurement reports to the gNB.

In 206, the gNB decides to execute LTM cell switch to a target cell, and transmits a MAC control element (MAC-CE) triggering LTM cell switch. The WTRU switches to the configuration of the LTM candidate target cell.

In 207, the WTRU performs random access procedure towards the target cell, if TA is not available.

In 208, the WTRU indicates successful completion of the LTM cell switch towards the target cell.

The following agreements and assumptions have been made in 3GPP RAN2:
Event triggered L1 measurement should be designed for the following LTM purposes:
Select the candidate beam/cell to trigger early synchronization;
Select the target beam/cell and trigger LTM cell switch procedure.

For event triggered L1 measurement, use of beam level measurement result for event evaluation is baseline: FFS for the cell level measurement.

Support the following LTM events based on beam specific quality of serving cell and candidate cells as the L1 LTM measurement events:
Event LTM2: Beam of serving cell becomes worse than absolute threshold;
Event LTM3: Beam of candidate cell becomes amount of offset better than beam of serving cell;
Event LTM4: Beam of candidate cell becomes better than absolute threshold;
Event LTM5: Beam of serving cell becomes worse than absolute threshold1 AND Beam of candidate cell becomes better than another absolute threshold2.

FFS on what beam(s) of the serving cell and neighboring cell is used for event evaluation;

FFS on the need of Event LTM1.

Support the beam config of both SSB and CSI-RS in L1 measurement resource configuration in LTM config: Working assumption: Same RS type should be used for both serving and neighboring cell for event LTM3 and event LTM5.

RAN2 assumes filtering of the L1 measure results is needed: it's up to RAN1 whether the specified L1 filtering is needed or ok to leave it to WTRU implementation.

For LTM event evaluation, TTT, hysteresis for entering/leaving, and/or beam specific (FFS for cell specific) offset can be applied: FFS on the need of measurement reporting once leaving condition is met.

### [MIMO Enhancement NR]

For 3GPP Release 19, one of the objectives for enhancement to MIMO is as follows: Specify enhancement to facilitate WTRU-initiated/event-driven beam management for reducing overhead and/or latency, assuming the unified TCI while leveraging (as much as possible) legacy CSI measurement and reporting configuration frameworks, targeting FR2 and sTRP with intra-and inter-cell beam management:
a) UL signaling content(s) (and procedure(s) as required) for WTRU-initiated/event-driven beam reporting facilitating fast beam switching;
b) UL signaling medium/container considering the WTRU-initiated/event-driven nature of the UL transmission, designed primarily for the purpose of beam reporting.

The following agreements and assumptions have been made in 3GPP RAN1:

### [On WTRU-Initiated/Event-Driven Beam Reporting, For the Agreed Trigger-Event2 (Quality of at Least One New Beam, Such as L1-RSRP, Becomes a Threshold Value Better Than the Current Beam).]

Regarding RS measurement for the current beam for Event 2, support both schemes:
Scheme-1: RS for current beam is the QCL RS in the indicated TCI state;
Scheme-2: the RS for current beam is the SSB which is QCLed with the QCL RS in the indicated TCI state;

Enabling one of either Scheme-1 or Scheme-2 is selected by NW;

The above QCL RS is the RS w.r.t. QCL-TypeD, if there are two QCL RSs in the indicated TCI state.

Regarding RS measurement for the new beam for Event 2, at least Option-3a is supported:

Option-3a (explicit manner): The RS(s) for new beam(s) are explicitly configured;

FFS: Option-3b/3c;

Option-3b: The RS(s) for new beam(s) are implicitly derived from QCL RS(s) of activated TCI state(s).

Option-3c: The RS(s) for new beam(s) are implicitly derived from QCL RS(s) of TCI state(s) in a configured subset of the legacy RRC-configured TCI state list.

Regarding UL signaling content(s) of L1-RSRP report depending on Event-2, in a report instance, at least Option-3 is supported.

Option-3: N≥1 beam(s) are reported in the report instance:
At least one of N reported beam(s) should satisfy the condition of Event-2;
N is configured by gNB (FFS: candidate value of ‘N’);
RRC can enable or disable whether current beam is always reported in addition to the N beams, when enabled by RRC, the current beam +N beams from the measurement RSs for new beam(s) are reported, and when disabled by RRC, N beams are reported.

### [On Beam Reporting Procedure]

Regarding Mode-A:
for Step-1, [Working assumption] at least support one-bit indication in the first PUCCH channel to request a resource for a second UL channel to carry beam report;
the DCI format in Step-2 comprises UL-grant DCI format, and the second channel in Step-3 is at least PUSCH: the UL-grant DCI format at least comprises DCI format 0_1/0_2; FFS: the DCI format in Step-2 comprises DL-grant DCI format, and the second channel in Step-3 is PUCCH.

Regarding Mode-B (pre-configured UL resource as the second channel): for Step-1, at least support one-bit indication in the first PUCCH channel to notify a second UL channel to carry beam report.

### [Further Down-Selected Events]

On WTRU-initiated/event-driven beam reporting, regarding trigger events, the following Event-1 and 7a/7b, are provided for down-selection or combination in RAN1 #118:
Event-1: Quality of the current beam is worse than a certain threshold;
Event-7a: Quality of at least one new beam, such as L1-RSRP, becomes a threshold value better than the RS derived from the activated TCI state with the worst quality;
Event-7b: Quality of at least one new beam, such as L1-RSRP, becomes a threshold value better than the RS derived from the activated TCI state with the best quality;

### [Perform LTM]

In this document, “perform LTM” or “perform LTM” procedures refers to performing any/all of the steps described in FIG. 2 for NR, or similar procedures for 6G. Specifically, early synchronization in DL and/or UL to one or more of the candidate cells, performing L1 measurements and reporting on one or more of the candidate cells, switching (i.e. performing handover) between candidate cells (“Perform LTM” can mean that the WTRU moves/switches between multiple candidate cells during the procedure).

### [Candidate Cell Sets]

The one or more candidate cell sets may be groups of more than one RRC configuration corresponding to a handover configuration for one or more candidate SpCells and optionally SCells. This may be modelled or received as one or more complete RRC Reconfiguration messages, one or more cell group configurations, or one or more cell configurations. Each of the candidate cell configurations may include a candidate configuration identifier, and each of the candidate cell groups may include a candidate cell group identifier. If the grouping is performed at RRC, the switching between different sets of candidate cells may include updating the serving cell indexes or candidate configuration indexes which are used in L1 and MAC signalling to refer to specific indexes (for example a MAC CE triggering the reconfiguration may include a candidate configuration index informing the WTRU which cell to perform the reconfiguration to).

The one or more candidate cell groups may be configured as a single list or group of candidate cell configurations at RRC. The grouping may occur at the early sync or LTM execution phase rather than the configuration phase-what this means is that the candidate cell set may be considered as a single group in terms of an RRC configuration list or group, while the cells selected for performing early sync, L1 measurements, and LTM execution depend on a further grouping into multiple subsets of the overall candidate cell list. In other words the grouping itself may not be modelled at RRC using candidate configuration identifiers, but the grouping is executed as part of the early sync or the LTM execution procedure.

Throughout this disclosure, when referring to an LTM candidate configuration, this may apply to any type of preconfigured cell information. For example, a WTRU may be configured with one or more conditional reconfigurations such as conditional handover (CHO), conditional PSCell addition (CPA) or conditional PSCell change (CPC) which are valid before and/or after a cell change, or valid in certain cells.

### [SSB]

Synchronization Signal Block or SS/PBCH block, which may include at least one of the following: PSS (Primary Synchronization Signal), SSS (Secondary Synchronization Signal), Physical Broadcast Channel PBCH (Data, MIB) and PBCH (DMRS). The SSBs may be transmitted by the NW node (e.g., base station, TRP, relay node, RIS unit) in different directions as beams. The number of SSB beams in an SSB burst set, which may be transmitted periodically within an interval (e.g., 5 ms) may depend on the carrier frequency. For example, an SSB burst may contain 4 SSBs for FR1 (<3GHZ), 8 SSBs for FR1 (3 to 6GHZ) and 64 SSBs for FR2. Certain SSBs may be transmitted as on-demand SSBs (OD-SSBs), which may possibly consist of a subset of SSBs in a burst. Such OD-SSBs may be transmitted aperiodically, semi-persistently, or periodically with certain periodicity. The transmission of such OD-SSBs may be triggered by the NW node or WTRU (e.g., via transmission of an UL WUS). Some SSBs may include slim/lean SSBs, which may comprise of PSS only, PSS and SSS-only, PBCH or a subset of MIB-only, for example.

### [CSI-RS]

channel state information reference signal, which may include at least one of the following: CSI-RS resource set (ID), CSI-RS resource (ID/index), resource mapping, power control offset values (e.g., with respect to PDSCH, SSB), scrambling ID, periodicity, offset and QCL info. CSI-RS may be transmitted in DL by the NW node as CSI-RS beams, via different resource types including periodic, semi-persistent and aperiodic.

### [CSI]

channel state information, which may include at least one of the following: channel quality index (CQI), rank indicator (RI), precoding matrix index (PMI), an L1 channel measurement (e.g., RSRP such as L1-RSRP, or SINR), CSI-RS resource indicator (CRI), SS/PBCH block resource indicator (SSBRI), layer indicator (LI) and/or any other measurement quantity measured by the WTRU from the configured CSI-RS or SS/PBCH (SSB) block.

### [Channel Conditions]

any conditions relating to the state of the radio/channel, which may be determined by the WTRU from: a WTRU measurement (e.g., L1/SINR/RSRP, CQI/MCS, channel occupancy, RSSI, power headroom, exposure headroom), L3/mobility-based measurements (e.g., RSRP, RSRQ, s-measure), an RLM state, and/or channel availability in unlicensed spectrum (e.g., whether the channel is occupied based on determination of an LBT procedure or whether the channel is deemed to have experienced a consistent LBT failure).

### [L1 Measurement]

An L1 measurement herein may consist of a measurement of RSRP, RSRP, RSSI, etc, performed by a WTRU of a cell, beam, set of cells, or set of beams. Such L1 measurement may be similar to L3 measurements reported in RRM, with differences in the filtering, reference signals measured, reporting mechanisms, etc.

### [L1 Measurement Can Apply Also to RRM Reporting]

Herein, measurements refers to L1 measurements for LTM. However, certain embodiments herein may apply also to RRM/L3 measurements, as well as other measurements (e.g., measurements of speed, location, height, traffic, etc).

### [L1 Measurement Events]

Herein, reference is made to L1 MIMO beam management events, and L1 LTM/mobility events, which use separate reporting mechanisms, resources, and triggers. However, certain embodiments herein may also apply to any other type of measurement events of separate types which interact either in terms of the reporting mechanism or the evaluation mechanism.

### [LTM Cell Switch Can Apply Also to Any Type of Handover Execution]

Herein, the LTM cell switch refers to L1/2 triggered mobility whereby a preconfigured RRC configuration is applied when the WTRU receives an indication using MAC CE or when a certain condition is met at the WTRU. However, certain embodiments may also apply to an RRC reconfiguration, an RRC conditional reconfiguration, as well as any other type of mobility procedure.

### [Radio Access Technology (RAT) Applicability]

Throughout this disclosure, the terms, channels, and protocol design for 5G NR is assumed, however it should be understood that the methods taught apply equally to any cellular network such as a 6G 3GPP system. In the context of a 6G or future generation wireless network, some functions may or may not be necessary, depending on the system architecture, protocol design, and physical channel design, however it is assumed that a system operates using the general principle that configurations are provided by an upper (e.g., RRC) layer which apply to multiple target cells, beam, or TRPs and the lower layer (e.g., MAC, L1) controls switching between the configurations.

In the following detailed description, numerous specific details are set forth to provide a thorough understanding of embodiments and/or examples disclosed herein. However, it will be understood that such embodiments and examples may be practiced without some or all of the specific details set forth herein. In other instances, well-known methods, procedures, components and circuits have not been described in detail, so as not to obscure the following description. Further, embodiments and examples not specifically described herein may be practiced in lieu of, or in combination with, the embodiments and other examples described, disclosed or otherwise provided explicitly, implicitly and/or inherently (collectively “provided”) herein. Although various embodiments are described and/or claimed herein in which an apparatus, system, device, etc. and/or any element thereof carries out an operation, process, algorithm, function, etc. and/or any portion thereof, it is to be understood that any embodiments described and/or claimed herein assume that any apparatus, system, device, etc. and/or any element thereof is configured to carry out any operation, process, algorithm, function, etc. and/or any portion thereof.

### Example Communications System

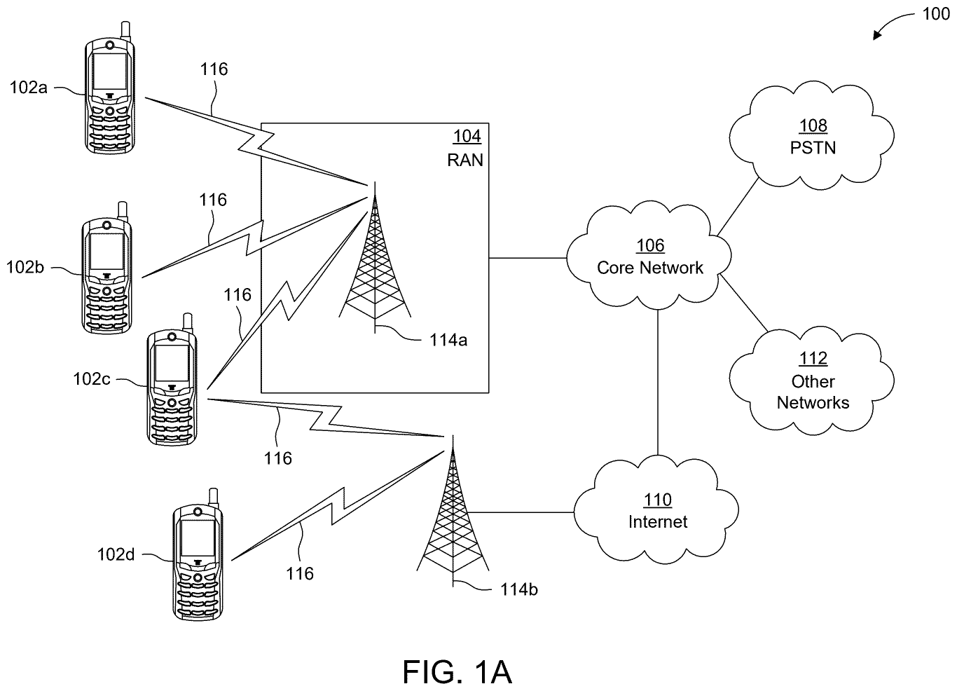

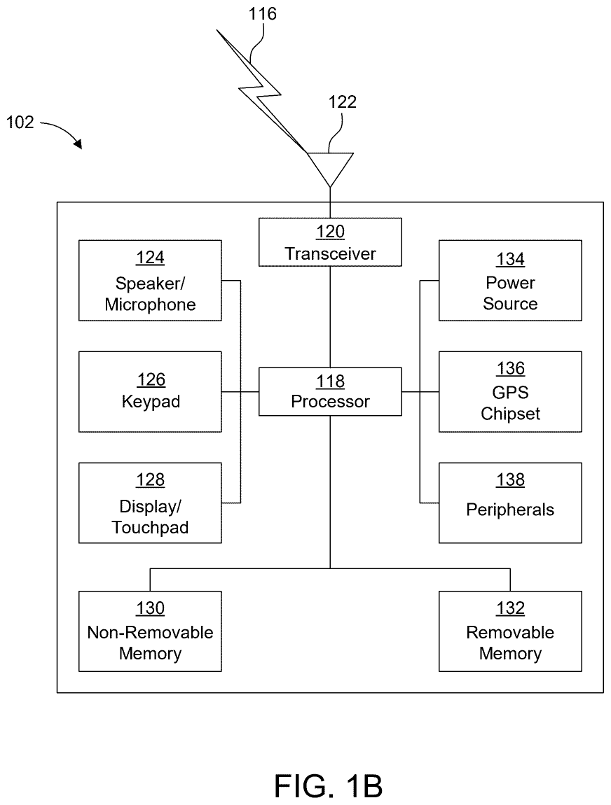

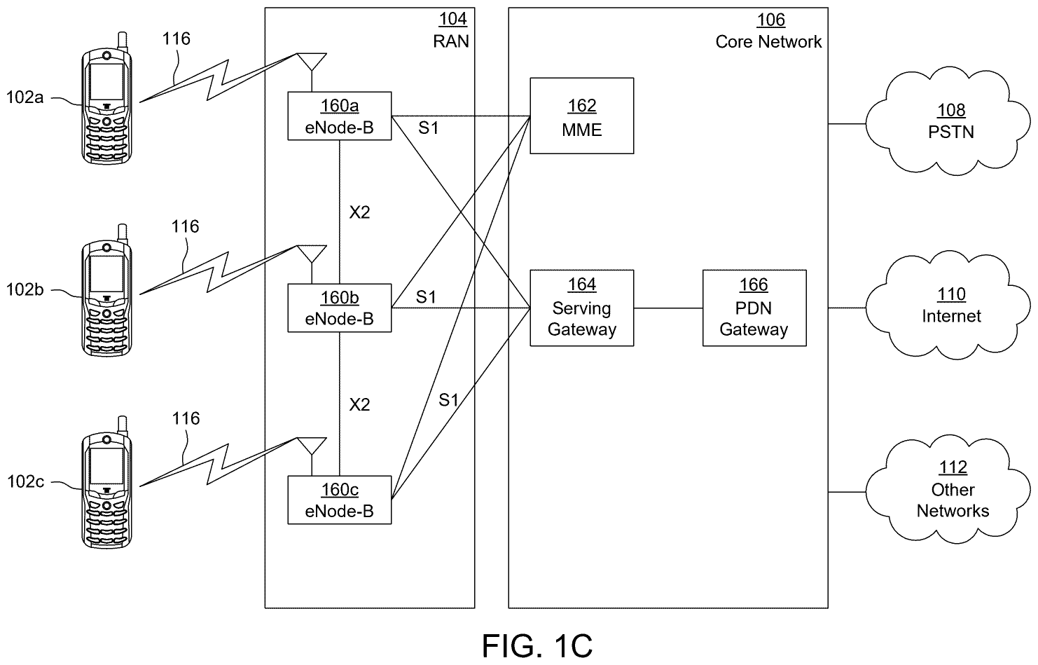

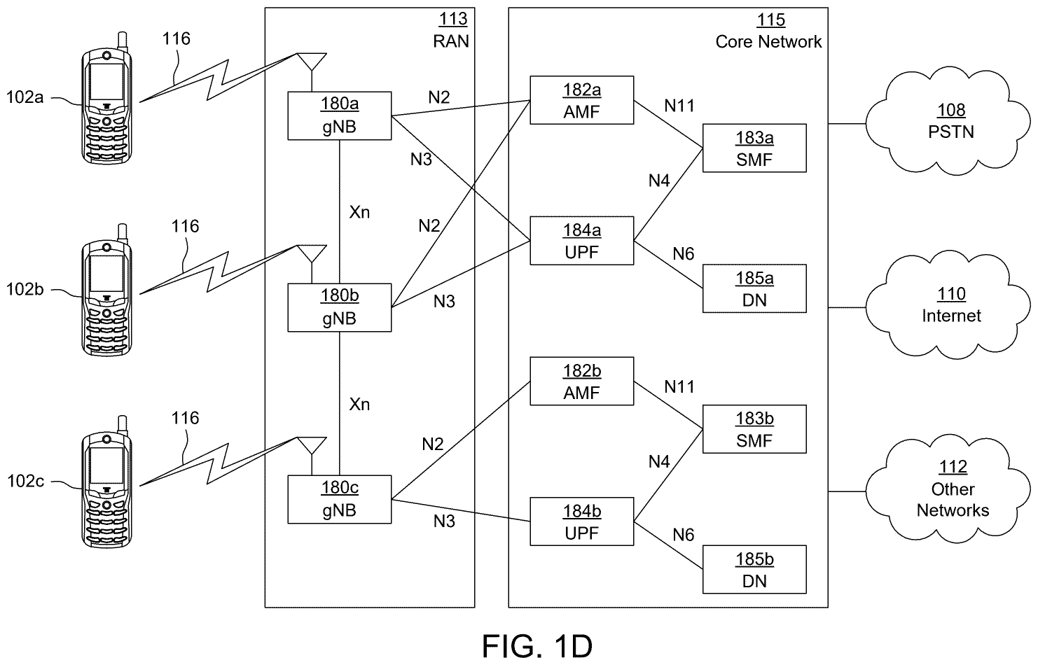

The methods, apparatuses and systems provided herein are well-suited for communications involving both wired and wireless networks. An overview of various types of wireless devices and infrastructure is provided with respect to FIGS. 1A-1D, where various elements of the network may utilize, perform, be arranged in accordance with and/or be adapted and/or configured for the methods, apparatuses and systems provided herein.

FIG. 1A is a system diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail (ZT) unique-word (UW) discreet Fourier transform (DFT) spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104/113, a core network (CN) 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include (or be) a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d, e.g., to facilitate access to one or more communication networks, such as the CN 106/115, the Internet 110, and/or the networks 112. By way of example, the base stations 114a, 114b may be any of a base transceiver station (BTS), a Node-B (NB), an cNode-B (cNB), a Home Node-B (HNB), a Home cNode-B (HeNB), a gNode-B (gNB), a NR Node-B (NR NB), a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in an embodiment, the base station 114a may include three transceivers, i.e., one for each sector of the cell. In an embodiment, the base station 114a may employ multiple-input multiple output (MIMO) technology and may utilize multiple transceivers for each or any sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In an embodiment, the base station 114a and the WTRUs 102a, 102b, 102c may implement radio technologies such as IEEE 802.11 (i.e., Wireless Fidelity (Wi-Fi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node-B, Home eNode-B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In an embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In an embodiment, the base station 114b and the WTRUs 102c, 102d may utilize a cellular-based RAT (e.g., WCDMA, CDMA2000, GSM, LTE, LTE-A, LTE-A Pro, NR, etc.) to establish any of a small cell, picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VOIP) services to one or more of the WTRUs 102a, 102b, 102c, 102d. The data may have varying quality of service (QOS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing an NR radio technology, the CN 106/115 may also be in communication with another RAN (not shown) employing any of a GSM, UMTS, CDMA 2000, WiMAX, E-UTRA, or Wi-Fi radio technology.

The CN 106/115 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/114 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other elements/peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together, e.g., in an electronic package or chip.

The transmit/receive element 122 may be configured to transmit signals to, or receive signals from, a base station (e.g., the base station 114a) over the air interface 116. For example, in an embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In an embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. For example, the WTRU 102 may employ MIMO technology. Thus, in an embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other elements/peripherals 138, which may include one or more software and/or hardware modules/units that provide additional features, functionality and/or wired or wireless connectivity. For example, the elements/peripherals 138 may include an accelerometer, an e-compass, a satellite transceiver, a digital camera (e.g., for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a virtual reality and/or augmented reality (VR/AR) device, an activity tracker, and the like. The elements/peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the uplink (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the uplink (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, and 102c over the air interface 116. The RAN 104 may also be in communication with the CN 106.

The RAN 104 may include cNode-Bs 160a, 160b, 160c, though it will be appreciated that the RAN 104 may include any number of cNode-Bs while remaining consistent with an embodiment. The cNode-Bs 160a, 160b, 160c may each include one or more transceivers for communicating with the WTRUs 102a, 102b, 102c over the air interface 116. In an embodiment, the cNode-Bs 160a, 160b, 160c may implement MIMO technology. Thus, the cNode-B 160a, for example, may use multiple antennas to transmit wireless signals to, and receive wireless signals from, the WTRU 102a.

Each of the cNode-Bs 160a, 160b, 160c may be associated with a particular cell (not shown) and may be configured to handle radio resource management decisions, handover decisions, scheduling of users in the uplink (UL) and/or downlink (DL), and the like. As shown in FIG. 1C, the cNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While each of the foregoing elements are depicted as part of the CN 106, it will be appreciated that any one of these elements may be owned and/or operated by an entity other than the CN operator.

The MME 162 may be connected to each of the eNode-Bs 160a, 160b, and 160c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the cNode-Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode-B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-ID as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in infrastructure basic service set (BSS) mode may have an access point (AP) for the BSS and one or more stations (STAs) associated with the AP. The AP may have an access or an interface to a distribution system (DS) or another type of wired/wireless network that carries traffic into and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11c DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier sense multiple access with collision avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High throughput (HT) STAs may use a 40 MHz wide channel for communication, for example, via a combination of the primary 20 MHz channel with an adjacent or nonadjacent 20 MHz channel to form a 40 MHz wide channel.

Very high throughput (VHT) STAs may support 20 MHz, 40 MHZ, 80 MHZ, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse fast fourier transform (IFFT) processing, and time domain processing, may be done on each stream separately. The streams may be mapped on to the two 80 MHz channels, and the data may be transmitted by a transmitting STA. At the receiver of the receiving STA, the above-described operation for the 80+80 configuration may be reversed, and the combined data may be sent to a medium access control (MAC) layer, entity, etc.

Sub 1 GHz modes of operation are supported by 802.11af and 802.1lah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV white space (TVWS) spectrum, and 802.11ah supports 1 MHZ, 2 MHZ, 4 MHZ, 8 MHZ, and 16 MHz bandwidths using non-TVWS spectrum. According to a representative embodiment, 802.11ah may support meter type control/machine-type communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHZ, 4 MHZ, 8 MHZ, 16 MHZ, and/or other channel bandwidth operating modes. Carrier sensing and/or network allocation vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In an embodiment, the gNBs 180a, 180b, 180c may implement MIMO technology. For example, gNBs 180a, 180b may utilize beamforming to transmit signals to and/or receive signals from the WTRUs 102a, 102b, 102c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., including a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as cNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards user plane functions (UPFs) 184a, 184b, routing of control plane information towards access and mobility management functions (AMFs) 182a, 182b, and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one session management function (SMF) 183a, 183b, and at least one Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration arca, termination of NAS signaling, mobility management, and the like. Network slicing may be used by the AMF 182a, 182b, e.g., to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (cMBB) access, services for MTC access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as Wi-Fi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, e.g., to facilitate communications between the WTRUs 102a, 102b, 102c and IP-enabled devices. The UPF 184a, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In an embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to any of: WTRUs 102a-d, base stations 114a-b, cNode-Bs 160a-c, MME 162, SGW 164, PGW 166, gNBs 180a-c, AMFs 182a-b, UPFs 184a-b, SMFs 183a-b, DNs 185a-b, and/or any other element(s)/device(s) described herein, may be performed by one or more emulation elements/devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

### Introduction

### [Simultaneous Event Driven Beam Management Reporting and Mobility Events]

Regarding mobility, several mechanisms for transmission of the mobility event report may be used. At least for some of the cases, a MAC CE may be used. The other option may be to use uplink control information (UCI), for example the same or similar mechanism as MIMO beam management. The main advantage of UCI is that the same mechanism as MIMO BM can be used. MAC CE has several technical advantages for the mobility use case. It provides a more reliable method for transmission of a report, and better resource utilization than UCI, because HARQ is used for transmission therefore there is no need to repeat the transmission multiple times and/or increase the risk of causing a mobility failure. MAC CE is also more flexible in terms of the amount of information that can be provided, therefore smaller or large reports can both be supported. MAC CE in most cases has a similar latency as UCI, because if the WTRU has an ongoing uplink transmission using PUSCH for which it has a grant, then the MAC CE can be included with this data. In case there is no grant, then there may be a disadvantage in terms of latency, because according to the current mechanism for acquiring a grant, the WTRU would first have to transmit a scheduling request (SR) using UCI to request a grant, then transmit a MAC CE containing buffer status report (BSR) to request resources to transmit the MAC CE containing the event report.

In addition, when the network has configured both L1 event triggering mechanisms (MIMO beam management using UCI, and LTM using MAC CE), even if these may operate independently, the outcomes of each function can affect the other. As an example, in case a mobility event is configured which uses the serving beam quality as one input (e.g., event LTM3), and the serving beam is defined as the beam corresponding to the currently active TCI state, then a beam management event causing that currently active TCI state to change, or imply an imminent change, also implies that the evaluation of a mobility event may be affected.

Therefore, when both MIMO beam management L1 reporting and LTM event reporting is enabled, it may be advantageous to use this combination to improve mobility reporting latency, in particular when there is no available uplink grant to transmit the report.

Therefore, when both MIMO beam management L1 reporting and LTM event reporting is enabled, it may be advantageous to ensure that one or the other mechanism triggering does not prevent the other to operate correctly (e.g., change of serving cell beam may cause LTM event to be delayed and hence handover failure may occur).

### Overview

### [LTM Candidate Configuration]

The gNB (e.g., a CU in case of CU/DU split architecture—note: RRC resides in CU) configures potential LTM candidates using RRC signalling. According to an embodiment the WTRU receives the LTM candidate configurations using an RRC Reconfiguration message, for example during the “LTM preparation” phase shown in FIG. 1.2.2. The WTRU may store the LTM candidate configurations to later apply upon receiving an indication using L1/2 signalling (e.g., MAC CE) to perform a cell switch, for example in the “LTM execution” phase shown in FIG. 2.

According to an embodiment, the configuration of potential LTM candidates may include candidate sets->for example a first set which may e.g., be suitable for a first path (for example, a WTRU turns left and takes first road) and a second set which may e.g., be suitable for a second path (e.g., WTRU turns right and takes second road)

According to an embodiment, some or all of the candidate set information is broadcast in system information, and the WTRU enables the pre-configuration of these broadcast configurations upon receiving an indication in dedicated signalling (e.g., RRC Reconfiguration) which refers to the broadcast one or more configurations (e.g., using an index or identifier)

According to an embodiment, the configuration may include all or a subset of the potential cells in a specific area (for example all cells belonging to the CU with which the WTRU is currently connected or cells within a particular geographical area). These cells may not yet have been detected or measured by the WTRU, but are configured in advance. According to an embodiment, after the initial configuration of LTM candidate configurations, the WTRU may receive an update to the configuration to modify, add, remove, or replace any part of the LTM candidate configurations.

According to an embodiment, the WTRU may receive an indication to enable or disable some or all the LTM configurations. For example, if it is predicted that the WTRU mobility would be better handled using L3 (e.g., RRC measurement report, RRC reconfiguration, conditional reconfiguration) then LTM may be disabled, and on the other hand if it is predicted that LTM would better suit the WTRU mobility then LTM may be enabled (e.g., a previously configured and disabled LTM configuration may be re-enabled).

The configuration may, according to an embodiment, be based on a prediction model internal to, and determined by, the network (e.g., by a network node (gNB)). This prediction may, for example, be based on what (according to the NW prediction model) is determined to be the WTRUs most likely paths.

According to an embodiment, the candidate cell configurations contain all or part of the information necessary to complete a reconfiguration (e.g., handover) to the candidate cell, such as channel configurations (e.g., PRACH, DPCCH, DPSCH), CORESET, BWP, security parameters, L2 parameters (e.g., MAC, RLC, PDCP), radio bearer configurations, and so on.

### [LTM Execution Trigger]

LTM execution trigger refers herein to a condition for performing LTM (e.g., a conditional handover trigger or measurement report trigger), which is either configured or indicated by the network to the WTRU, or estimated/determined by the WTRU.

A trigger may be based on any of the following (a-k):
a) time, e.g., (a1-a3):
   a1) absolute or relative time measured time at WTRU;
   a2) SFN (system frame number);
   a3) subframe number.
b) radio quality measurement or predicted radio quality one or more of the serving cells or target cells, e.g., (b1-b9):
   b1) RSRP (beam or cell);
   b2) RSRQ (beam or cell);
   b3) cri-RI-PMI-CQI;
   b4) cri-RI-i1;
   b5) cri-RI-i1-CQI;
   b6) cri-RI-CQI;
   b7) cri-RSRP;
   b8) ssb-Index-RSRP;
   b9) cri-RI-LI-PMI-CQI.
c) position, e.g., (c1-c2):
   c1) an area (e.g., defined by reference point and radius) or range of co-ordinates;
   c2) a distance threshold from a reference location.
d) Any L3 measurement event, for example (d1-d8):
   d1) event A1 (Serving becomes better than threshold);
   d2) event A2 (Serving becomes worse than threshold);
   d3) event A3 (Neighbor becomes offset better than SpCell);
   d4) event A4 (Neighbor becomes better than threshold);
   d5) event A5 (SpCell becomes worse than threshold1 and neighbor becomes better than threshold2);
   d6) event A6 (Neighbor becomes offset better than SCell)
   d7) event B1 (Inter RAT neighbor becomes better than threshold)
   d8) event B2 (PCell becomes worse than threshold1 and inter RAT neighbor becomes better than threshold2).
e) Any L1 measurement event or condition, for example any event defined which utilizes L1 beam measurements to evaluate whether a criteria or condition is met. For example (e1-e2):
   e1) LTM (a1a-e1e):
   e1a) event LTM1: Beam of serving cell becomes better than absolute threshold;
   e1b) event LTM2: Beam of serving cell becomes worse than absolute threshold;
   e1c) event LTM3: Beam of candidate cell becomes amount of offset better than beam of serving cell;
   e1d) event LTM4: Beam of candidate cell becomes better than absolute threshold;
   e1e) event LTM5: Beam of serving cell becomes worse than absolute threshold1 AND beam of candidate cell becomes better than another absolute threshold2.
   e2) MIMO BM (e2a-e2d):
   e2a) event-1: Quality of the current beam is worse than a certain threshold;
   e2b) event-2 (Quality of at least one new beam, such as L1-RSRP, becomes a threshold value better than the current beam);
   e2c) event-7a: Quality of at least one new beam, such as L1-RSRP, becomes a threshold value better than the RS derived from the activated TCI state with the worst quality;
   e2d) event-7b: Quality of at least one new beam, such as L1-RSRP, becomes a threshold value better than the RS derived from the activated TCI state with the best quality.
f) any time or location based condition, for example (f1-f3):
   f1) time measured at WTRU is within a duration from threshold;
   f2) distance between WTRU and referenceLocation1 is above threshold1 and distance between WTRU and referenceLocation2 is below threshold2;
   f3) distance between WTRU and the serving cell moving reference location is above threshold1 and distance between WTRU and a moving reference location is below threshold2.
g) Any combination of L3, L1, time, location-based conditions or events. For example (g1-g3):
   g1) time measured at WTRU is within a duration from threshold AND Beam of candidate cell becomes better than absolute threshold, and so on;
   g2) distance between WTRU and referenceLocation1 is above threshold1 and distance between WTRU and referenceLocation2 is below threshold2 AND Beam of candidate cell becomes amount of offset better than beam of serving cell;
   g3) distance between WTRU and the serving cell moving reference location is above threshold1 and distance between WTRU and a moving reference location is below threshold2 AND Beam of serving cell becomes worse than absolute threshold1 AND Beam of candidate cell becomes better than another absolute threshold2.
h) Any predicted event (e.g., based on predicted CSI information)
i) An explicit indication from the network. For example, the WTRU may enable CSI reporting based on an explicit indication (e.g., a MAC CE) received from the network, then execute LTM cell switch upon receiving a second MAC CE from the network.
j) A measured, predicted, or estimated throughput, error rate, buffer status, or QoS parameter.
k) An evaluation metric, for example a time-to-trigger, a hysteresis, offset (e.g., a radio quality measurement offset), a measurement filtering configuration.

The trigger may include one or more conditions under which the WTRU is allowed to any action related to LTM. For example, the WTRU may perform one or more of the following procedures (a-g):
a) Early TA acquisition (a1-a2):
   a1) WTRU may trigger a RACH to a target LTM cell (a1a-a1c):
   a1a) WTRU may receive a TA value in a RAR. RAR may come from target cell, or via source cell;
   a1b) WTRU may receive a TA value in a MAC CE triggering the cell switch;
   a1c) WTRU may perform power ramping and preamble retransmission on the target if a RAR/MAC CE is not received.
a2) WTRU may acquire the TA value of a candidate LTM cell by measurement, and trigger when complete. the WTRU may support and be configured with WTRU-based TA measurement, whereby the WTRU acquires the TA value(s) of the candidate cell(s) by measurement.
b) Switching off CSI reporting (b1-b3):
   b1) the WTRU may be allowed to, or required to, switch off CSI reporting in order to reduce reporting overhead in the uplink;
   b2) the CSI reporting may be reduced rather than switched off. For example, reduced number of cells or beams reporting, or a reduced frequency of reporting;
   b3) the WTRU may resume CSI reporting when the condition is no longer met.
c) Switching on or updating the CSI reporting configuration, for example, the WTRU may be required to perform and report CSI measurements on one or a subset of LTM candidate cells during the window;
d) Performing LTM cell switch. Conditions or criteria under which the WTRU is allowed to trigger LTM cell switch;
e) Monitoring PDCCH on a target cell. The WTRU may be configured to monitor on a target cell for a DCI scheduling PDSCH or indicating one or more actions on the target cell, for example to initiate the cell switch procedure.
f) Performing BFR or RLM on a target cell. The WTRU may be configured to monitor BFD (beam failure detection) resources on a target cell, or perform RLM (radio link monitoring) on a target cell during the window.
g) Activating or deactivating certain SCells. The WTRU may be configured with one or more specific SCells which should be active or not active during the window.

### [RACH-Less CHO and Early TA Acquisition]

To enable RACH-less conditional handover, whereby the WTRU is not required to send a random access preamble or perform a random access procedure on the target cell following a reconfiguration trigger but rather the WTRU performs PDCCH reception and uplink transmission using the TA already provided, the WTRU may perform an early TA acquisition procedure with candidate cell(s) before receiving the cell switch command or before triggering a conditional reconfiguration (a-j):
a) according to an embodiment, and early TA acquisition may be performed using contention-free random access (CFRA) triggered by a PDCCH order from the source cell, following which the WTRU may send a preamble towards a candidate cell. The information that identifies the allocated CFRA resource may be indicated in the PDCCH order to enable shared preamble resource among multiple WTRUs in the RRC configuration-the source gNB dynamically indicates which WTRU uses the resource at any specific time;
b) according to an embodiment, this may be performed upon receiving a MAC CE indicating to perform a RACH transmission on a target cell;
c) according to an embodiment, this may be performed by transmitting using a contention-based random access (CBRA) preamble;
d) according to an embodiment, and in order to minimize the data interruption of the source cell due to CFRA towards the candidate cell(s), the WTRU doesn't receive RAR at all. Source cell may trigger a preamble retransmission/power ramping using another PDCCH order, e.g., if the preamble was not received. In this case, the TA may be provided from the target cell to the source cell, and provided to the WTRU in a MAC CE triggering cell switch or enabling conditional LTM to one or more target cells;
e) according to an embodiment, the WTRU may receive a TA value from the target cell in a random access response (RAR). According to an embodiment, the WTRU may receive a TA value from the source cell in a random access response (RAR). If the WTRU does not receive a RAR in response to transmitting the preamble (e.g., within a prescribed time), the WTRU may retransmit a preamble using a higher transmission power;
f) according to an embodiment, the WTRU may store the received TA value to be used later when a reconfigure trigger occurs. The WTRU may store the TA value for a limited period of time (e.g., a validity timer) and may trigger or be triggered to perform a new TA acquisition procedure when the time expires;
g) according to an embodiment, the WTRU may receive and/or stored multiple TA values associated with more than one cell;
h) according to an embodiment the WTRU may obtain the TA value of the target cell by measurement;
i) if the WTRU has stored a valid TA value of a candidate cell when a cell switch is triggered towards that candidate cell (either triggered by the NW using an explicit cell switch command, or triggered by the WTRU upon meeting a trigger condition), then the WTRU performs a RACH-less handover. For example, the WTRU may execute LTM (e.g., apply a pre-configured RRC configuration to a new SpCell) upon determining that a measured radio quality of the target cell is above a threshold;
j) the WTRU may support and be configured with WTRU-based TA measurement, whereby the WTRU acquires the TA value(s) of the candidate cell(s) by measurement. If the cell switch command does not contain a TA value, and the WTRU has acquired a TA measurement, the WTRU performs a RACH-less handover if it has been configured to do so by RRC.

### [TA Validity]

A WTRU may determine a received/stored TA to be valid based upon any one of the following (a-g):
a) a validity timer pre-configured to be used with TA value;
b) a validity timer received with the TA value;
c) based upon a condition on the DL cell timing of the source cell and the DL cell timing of the candidate cell for which TA is received/stored. In one example, a WTRU may consider the TA valid while the difference of the DL cell timing of the source and candidate cell is less than a configured threshold. In one example, a WTRU may consider the TA valid while the difference of the DL cell timing of the source and candidate cell is within a configured range;
d) based upon a condition on the DL cell timing of the candidate cell. In one example, a WTRU may consider the TA valid if the difference of the DL cell timing of the target cell at the time of the TA reception is not different by more than a certain configured value/range than the current DL cell timing of the same target cell;
e) based upon a condition on the WTRU mobility. In one example, a WTRU may consider the TA valid if the WTRU is static (not moving) or moving below a certain configured speed threshold;
f) based upon a condition on the WTRU location. In one example, a WTRU may consider the TA valid if it has determined that it has not changed its location by more than a certain configured threshold (e.g., x meters) after the TA acquisition;
g) based upon a condition that a WTRU-based TA measurement is available and a cell quality or beam quality measurement is above a threshold.

### [WTRU Based TA Calculation Report]

According to an embodiment, the WTRU may trigger an event when a WTRU-based TA acquisition has been completed, for example may transmit a MAC CE, CSI, or other uplink indication to the source cell or the candidate cell when a TA has been obtained based on WTRU measurement.

According to an embodiment, the WTRU may trigger an event based on a measurement criteria (e.g., RSRP or any of the other triggers listed above), and may send the corresponding report only if a TA has additionally been obtained, for example a TA is available due to a prior WTRU-based TA acquisition. According to an embodiment, a report or an LTM execution trigger caused due to a measurement based event or trigger may be delayed until a WTRU-based TA acquisition is completed. That is, a measurement event (e.g., a beam RSRP is above a threshold) may cause the WTRU to initiate a WTRU-based TA acquisition, then a trigger is executed when both the measurement event is satisfied and the TA has been obtained.

According to an embodiment, in response to receiving a report from the WTRU (e.g., WTRU-based TA acquisition has been performed an a beam or cell measurement is above a threshold), the network may transmit to the WTRU a command to enable conditional LTM evaluation, for example in a MAC CE. The WTRU may receive the command, and based on the content of the command may enable conditional LTM evaluation based on determination of one or more measurement conditions.

### [Beam Refinement on a Target Cell Before or During Handover]

The WTRU may perform beam refinement on a target cell before or during a handover and before the WTRU accesses the target cell, such that a WTRU first performs measurement of SSB resources, then selects a subset of CSI-RS resources to measure based on the SSB measurements (e.g., based on the best SSB measured). Then the WTRU may perform measurements on the selected subset of CSI-RS resource and determines a best CSI-RS resource. The selected best CSI-RS resource can be indicated before a handover takes place (e.g., to a source cell), or upon initial access (e.g., to a target cell), rather than performing the beam refinement only after a connection to a target cell is completed.

### [Reporting CSI-RS Measurements]

The WTRU may report the measurements of the subset of CSI-RS resources using CSI reporting on PUCCH to the source cell. The report may alternatively be transmitted using a MAC CE or an RRC measurement report, or any other type of uplink signaling. The report may contain one or more of (a-i):
a) RSRP (beam or cell);
b) RSRQ (beam or cell);
c) cri-RI-PMI-CQI;
d) cri-RI-i1;
e) cri-RI-i1-CQI;
f) cri-RI-CQI;
g) cri-RSRP;
h) ssb-Index-RSRP;
i) cri-RI-LI-PMI-CQI.

### [Enabling CSI-RS Measurements]

The WTRU may determine, based on a trigger a subset of CSI-RS to measure. For example, the WTRU may determine based on a pre-configured association (e.g., configured by RRC) between SSB and CSI-RS resources. The WTRU may determine based on an indication of an SSB or determining a best SSB from performed SSB measurements.

The subset of CSI-RS may be indicated explicitly in a random access response (e.g., using a pointer to one of multiple subsets) or may be indicated implicitly (e.g., the WTRU enables a subset of CSI-RS depending on a reported or indicated SSB when the RAR is received). The WTRU may alternatively enable the subset of CSI-RS measurements when the WTRU receives a PDCCH order triggering early TA acquisition, while the RAR or MAC CE containing a TA in response to the PRACH preamble transmission for TA acquisition activates the configured grant.

The CSI-RS measurements may be configured temporarily. For example, the WTRU may activate CSI-RS measurements for a certain time period, or a certain number of reports, which may be configured or predefined. The WTRU may deactivate CSI-RS measurements, for example, when a best SSB changes, or when an SSB or CSI-RS measurement goes below a threshold.

### [Configured Grant Activation]

The WTRU may receive an indication to activate a grant from either a source or a target cell this may be e.g., a type 2 configured grant, whereby the first cell configures the grant and the second cell activates the grant, an explicit grant (a direct indication of the grant to use), a pointer to one or more preconfigured grants (e.g., previously configured by RRC).

An indication of the grant may be a pointer to a configured grant corresponding to a reported SSB, or may be a set of configured grants corresponding to multiple CSI-RS associated with a reported SSB.

The configured grant activation may be received in a PDCCH order (e.g., triggering TA acquisition), in a MAC CE (e.g., triggering LTM), or in a RAR (e.g., received from the source or the target, containing a TA value to use for RACH-less handover).

The WTRU may autonomously activate a configured grant based on a condition. For example, any of the LTM execution triggers previously listed in this section.

### [Hyper Cell]

In some potential designs/implementations, the presence of a “cell” may be hidden from the WTRU-for example, the network may adapt all of part of its configuration to the configuration the WTRU may have been provided with, or individual beams are configured to the WTRU without the WTRU needing to have visibility of the physical location of those beams. By enabling large scale coordination of TRPs a WTRU may experience cell centre-like data transmission and reception across the network. For moving WTRUs, the serving TRPs may be dynamically selected and may be enabled without indicating a cell switch to the WTRU (e.g., the network may adapt to the WTRU configuration). In some cases, the different TRPs within a “hyper-cell” may transmit identical downlink synchronization signals, or transmit using a single resource configuration. The WTRU may be configured to measure “resources” in the downlink or transmit using “resources” in the uplink, which are common to more than one TRP and which the WTRU does not need to know the physical location of the signals. In this case, an uplink SRS may be needed for the network to determine the best uplink (for example, some scenarios such as uplink-only TRP may require this).

### [Uplink Reference Signal]

“SRS” refers to Sounding Reference Signal, and may be a reference signal transmitted by the WTRU in the uplink. This may be used by the network (e.g., gNB) to estimate the uplink channel quality. SRS may be used to provide information to the network about multipath fading, scattering, Doppler, and power loss of the transmitted signal. Sounding reference signals are uplink physical signals employed by user equipment (WTRU) for uplink channel sounding, including channel quality estimation and synchronization. Unlike Demodulation reference signals (DM-RS), SRS is not associated with any physical uplink channels and they support uplink channel-dependent scheduling and link adaptation. SRS may assist with codebook-based closed-loop spatial multiplexing, control uplink transmit timing, reciprocity-based downlink precoding in multi-user MIMO setups, quasi co-location of physical channels and reference signals.

The network may perform measurements on the WTRUs transmitted SRS on one or multiple TRPs. According to an embodiment, the WTRU selects SRS resources for the TRPs which provide the best measured downlink beams. The WTRU may transmit using more than one SRS resource representing multiple potential target TRPs. The WTRU may include an indication of a downlink measurement value (e.g., RSRP). The WTRU may include an indication of only the downlink measurement associated with the SRS resource selection, or may include an indication of multiple downlink measurements (e.g., the best N beams).

The network may perform uplink measurements on one or more TRPs. The network may co-ordinate measurements, for example by exchanging measurement information between network node or with a central node. The network may determine, based on the measurement coordination, to select a new TRP or cell for the WTRU. According to an embodiment, the WTRU transmits uplink SRS to only one TRP and includes downlink measurements, and in these embodiments the network may need to coordinate (e.g., only) between the target and source TRP, rather than the multiple potential targets.

According to an embodiment, the network may determine, based on measuring SRS resource set transmissions (e.g., uplink beam sweep) using resources determined by the WTRU based on downlink measurements, a best fine beam to configure the WTRU with upon cell or TRP change.

According to an embodiment, an intermediate node (e.g., a relay) may be employed to act as a network node. The intermediate node may perform measurements of the WTRU transmitted uplink SRS and convey measurements to a traditional (e.g., fixed TRP) network node.

According to an embodiment a network node may be configured to operate as an uplink only TRP.

According to an embodiment, the network node may be deployed on an arial vehicle (e.g., drone) or on a satellite (e.g., NTN cell)

### [Cell Switch]

A cell switch command may be received in a downlink signal such as DCI, MAC CE. This cell switch command may be receive from a source cell (e.g., like NR) or from a target cell (e.g., a cell determined to be the best cell). According to an embodiment, for example when “hyper cell” is used, the cell may be switch without notifying the WTRU, but rather the network configures, based on uplink measurements, to use a new TRP with the same configuration as the previous one.

According to an embodiment, an uplink and a downlink connection may be separately managed. For example, mobility based on reported downlink measurements may be used to manage downlink channels and TRPs, while the network selects uplink channels and TRPs based on uplink measurement signals.

### [Scheduling Request and Report Transmission]

In the legacy system, when a WTRU has some uplink data to transmit (including when a MAC CE is available for transmission), the WTRU can transmit this on PUSCH if it has enough available uplink grants (enough granted resources on PUSCH). In case there are not enough grants to transmit all of the pending uplink data, then the WTRU transmits according to the priority of the data (for example, MAC CE usually has higher priority than other user data). If the WTRU does not have sufficient uplink grants, then the WTRU transmits a BSR to indicate the amount of data available for transmission, to request more grants. If the WTRU does not have sufficient (e.g., none) grants to transmit even a BSR, then the WTRU first transmits a scheduling request (SR) to obtain a grant for transmitting the BSR.

In the context of mobility, and specifically LTM, the latency of report transmission is crucial for meeting the low latency and interruption which LTM is designed for. Any delays in report transmission will also cause a delay to mobility decisions (e.g., cell switch command) which in turn increases the risk of handover failure (HOF) or radio link failure (RLF). As LTM was designed with the aim of minimizing latency and interruption, and as the release 18 LTM uses ongoing CSI measurement reporting at L1 to ensure low latency it is important that any Release 19 enhancements perform at least as well as Release 18 in terms of latency. Introducing event triggered reporting at L1 is intended to reduce the reporting overhead, but it should not be at the cost of increased latency or handover failure. For this reason, any event triggered report should be transmitted as soon as possible to support fast mobility decisions.

If the WTRU does not have sufficient grant to transmit a MAC CE containing a mobility event triggered measurement report, then using the existing mechanism of sending SR and BSR has a risk of delaying the handover decision. However, for MIMO beam management, a new mechanism is also being designed with low latency. While MAC CE offers the advantage of flexibility (MAC CE can be of varying size, allowing different report lengths depending on the available measurement results) and reliability (MAC CE is transmitted on PUSCH using HARQ), use of UCI offers a latency advantage in the case of not enough uplink grant for PUSCH.

According to an embodiment, the WTRU transmits a MAC CE when there is available uplink grant. If there is not enough available uplink grant, then instead of transmitting a scheduling request, the WTRU may alternatively or additionally transmit an indication using PUCCH that one or more LTM events have been triggered, or that there are available mobility measurement results to send. This indication may be carried as part of a scheduling request, as an indication that the scheduling request is for transmission of a high priority mobility report, which would avoid the need to additionally send a BSR.

In case MIMO beam management events are configured, then PUCCH resources would also be configured for transmission of beam management event reports. Currently, 3GPP are discussing two modes of transmission of beam management reports, the network would configure which of the modes would be in use for a given event. For transmission of an LTM report using MIMO beam management reporting mechanism, several options may be possible.

Mode-A (a-c):
a) In step 1 of mode A, The WTRU may transmit one or more bits to indicate whether the subsequent transmission is a beam management report, a mobility report, or both, in a first PUCCH channel to request a resource for a second UL channel to carry beam or mobility report (a1-a5):
   a1) the one or more bits may indicate an event ID;
   a2) the one or more bits may be encoded in a new UCI format, or in one of the existing formats such as SR or CSI;
   a3) The one or more bits may occur in different SR/UCI resources. For example, a resource may be reserved for different types of event;
   a4) The one or more bits may be used to indicate whether the WTRU has subsequent information to transmit in a MAC CE or in a UCI format;
   a5) the one or more bits may simply indicate that the WTRU has some more to transmit in a second UL channel, without distinguishing whether this is a beam report or a mobility report.
b) In step 2 of mode A, the DCI format comprises an UL-grant DCI format, and the second channel in Step-3 may be PUSCH or PUCCH (b1-b3):
   b1) the UL-grant DCI format may comprise of DCI format 0_1/0_2 and the second channel may be PUSCH;
   b2) the UL-grant DCI format may comprise of DL-grant DCI format, and the second channel in Step-3 is PUCCH;
   b3) the network may, in response to WTRU indicating a mobility event has occurred in step 1, schedule PUSCH resources for transmission of a MAC CE.
c) In step 3 of mode A, the WTRU may transmit additional information, for example (c1-c6):
   c1) the WTRU may transmit one or more bits in the second UL channel (which could be PUSCH or another PUCCH resource) to indicate the occurrence of a mobility event-e.g., one bit to indicate a mobility event, or more than one bit to identify the event which has been triggered;
   c2) The WTRU may transmit mobility measurement results, for example RSRP of serving and/or candidate beams on other cells;
   c3) The WTRU may transmit one or more event IDs;
   c4) The WTRU may transmit an indication of the size of MAC CE that needs to be transmitted. This may be explicit (e.g., number of bits or bytes) or may be implicit (e.g., indication of MAC CE format ID, or event ID);
   c5) the WTRU may transmit a MAC CE in this step, if it has indicated a mobility event in step 1 or if the network explicitly schedules a PUSCH resource in step 2;
   c6) In response to the WTRU indicating that a mobility event has been triggered in step 3, the WTRU may receive a (e.g., further) PDCCH DCI to schedule PUSCH resources for MAC CE transmission.

Mode-B is similar to Mode A (and the same step numbering is used), with the primary difference being that a resource is pre-configured for transmission of a report in mode B step 3. For mode B step-1, one or more bits may be indicated in the first PUCCH channel to notify (mode A step 1: to request) a second UL channel to carry beam report. For mode B, the WTRU may transmit a beam report, a combined beam and mobility report, or a MAC CE for mobility report in the pre-configured resource.

According to an embodiment, the WTRU may include an indication of a mobility event or mobility measurement results in any one or more steps of the beam reporting procedure.

According to an embodiment, the WTRU may include only mobility results, may include both beam results and mobility results, or may include beam results only, with an indication of a mobility event or further mobility information to transmit in a MAC CE or other message.

### [Prioritization of Report Contents]

According to an embodiment, the WTRU may prioritize one or more types of event or report content. For example, if a beam event and a mobility event occurs before the next report transmission resource occurrence and the available transmission resources are not enough to transmit all of the information, then the WTRU may prioritize using one or more of the following conditions (a-c):
a) A prioritization of one type of event over another (e.g., mobility report with higher priority than beam report);
b) A prioritization configured per event ID type (e.g., some mobility events may have higher priority than some but not all beam events);
c) A prioritization determined based on the measurement results, for example (c1-c4):
   c1) if a serving beam measurement is below a threshold then prioritize mobility results;
   c2) if a target beam if above a threshold then prioritize mobility results;
   c3) include the event results corresponding to the best results (e.g., this may be one or more serving cell beams or candidate cell beams, depending on the measurement value, even ID, event threshold, or assigned priority);
   c4) prioritize the most comprehensive results (e.g., a candidate cell mobility report may have more suitable beam results than a serving cell beam report, or vice-versa).

The prioritization may apply to any one or more of the beam reporting procedures. For example, if a limited number of events can be indicated in step 1 (mode A or B), then the indication may prioritize particular events. For example, if the resource in step 3 (mode A or B) is limited, then the WTRU may include results according to a prioritization rule. Note: the difference mode A-mode B is that reporting resources are preconfigured in mode B vs. provided in mode A. in either case the resources may not be sufficient, so the WTRU may apply a prioritization rule, e.g., to include the highest priority results in the limited resources.

According to an embodiment, a beam event may occur while the WTRU already has a PUSCH resource available for transmission of a MAC CE. In this circumstance, a similar embodiment can be applied-for example, the WTRU transmits a MAC CE mobility report including an indication of beam results or beam events triggered.

### [Interaction of Measurement Events]

According to an embodiment, the WTRU may receive configurations and criteria for reporting of beam management (BM) LI measurement events and configuration and criteria for reporting of mobility L1 (LTM) measurement events, whereby both types of events are reported and evaluated in parallel (e.g., simultaneously).

According to an embodiment the mobility measurement event and/or the beam event may include a time to trigger (TTT) parameter. According to an embodiment, the WTRU may determine, based on the criteria for reporting of LTM events, to start a TTT for reporting. (e.g., Event LTM4: Beam of candidate cell becomes better than absolute threshold). According to an embodiment, the WTRU may determine, while TTT for the LTM event is running, that a beam event criteria has been met. (e.g., trigger-Event2 (Quality of at least one new beam, such as L1-RSRP, becomes a threshold value better than the current beam.)). According to an embodiment, under these conditions, the WTRU may update the serving cell beam or beams being considered for mobility event evaluation based on the serving cell beam or beams which triggered the beam event. According to an embodiment, the WTRU may do this automatically based on a beam event being triggered. According to an embodiment, the WTRU may report the beam event first, then update the beam or beams being used for mobility event evaluation upon receiving a beam indication (e.g., TCI state activation) for the serving cell.

According to an embodiment, the candidate beam set used for a candidate cell or serving cell mobility measurement event evaluation or for beam event evaluation may be updated upon receiving an indication (e.g., MAC CE) from the serving cell, for example TCI state activation on a candidate cell.

According to an embodiment, if the WTRU is using SSB measurements to evaluate mobility events, and CSI-RS measurements to evaluate beam events, the WTRU may update the mobility event evaluation using the SSB associated by configuration with the CSI-RS corresponding to the active TCI state, and vice-versa (CSI-RS associated to the evaluated SSB).

According to an embodiment, the triggering of one of the types of event may update the evaluation criteria for another type of event. For example, triggering of a beam event may change (increase or decrease) the threshold or time to trigger for a mobility event, or vice-versa.

According to an embodiment, the WTRU may suspend or defer triggering or reporting of one event if another occurs. For example, if a mobility event time to trigger is running based on a particular serving or candidate beam, the WTRU may postpone triggering a beam event corresponding to one or more of the beams being used for mobility event evaluation, until time to trigger stops or expires.

According to an embodiment, the WTRU selects an action to take depending on a criteria. For example, the WTRU may suspend triggering a beam event if a remaining time to trigger for a mobility event is less than a threshold, or may update the beam being used for mobility event evaluation otherwise.

According to an embodiment, the WTRU includes an indication in the mobility and/or beam evet report, to identify what interaction has taken place (e.g., suspend or defer a trigger, update the beam used in evaluation, etc).

The following summarizes embodiment of a method, implemented by a WTRU in a wireless communication network, for reporting mobility measurement results.

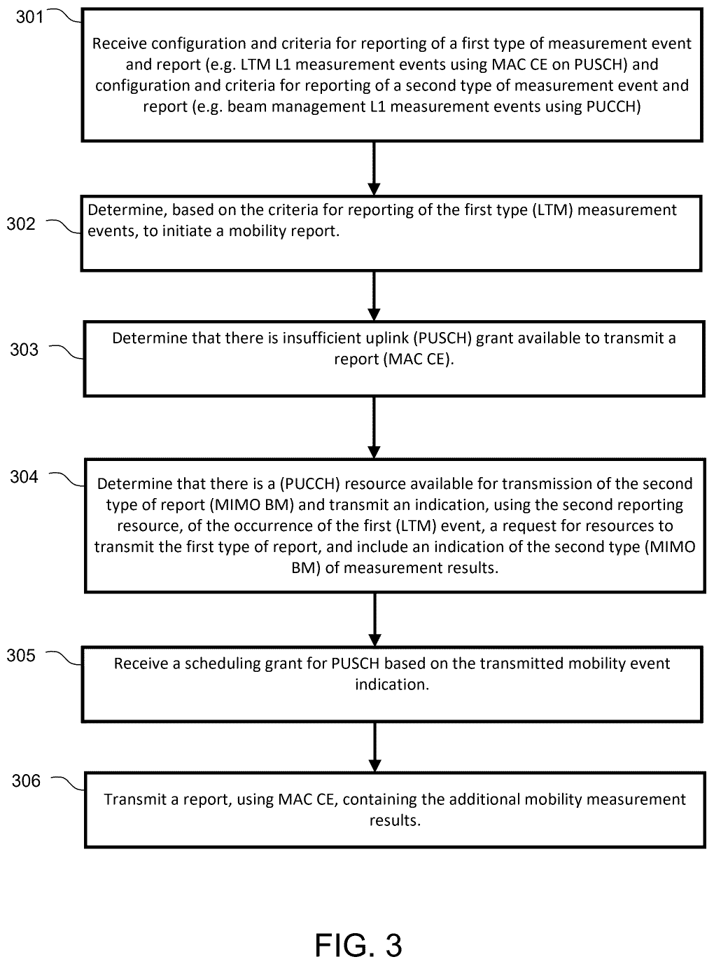

Embodiments relate to opportunistic use of uplink control channel resources to transmit an indication of L1 measurement events. When two types of reporting are configured (e.g., both LTM LI events using MAC CE, and MIMO beam management events using PUCCH), the WTRU may use the second mechanism (e.g., MIMO BM resource) to provide an indication of the first (e.g., LTM) event, in case there is no UL grant available for MAC CE transmission and a MIMO reporting resource is available. The method, depicted in FIG. 3, comprises:

In 301, receiving configuration and criteria for reporting of a first type of measurement event and report (e.g., LTM L1 measurement events using MAC CE on PUSCH) and configuration and criteria for reporting of a second type of measurement event and report (e.g., beam management L1 measurement events using PUCCH);.

In 302, determining, based on the criteria for reporting of the first type (LTM) measurement events, to initiate a mobility report;

In 303, determining that there is insufficient uplink (PUSCH) grant available to transmit a report (MAC CE);

In 304, determining that there is a (PUCCH) resource available for transmission of the second type of report (MIMO BM) and transmit an indication, using the second reporting resource, of the occurrence of the first (LTM) event, a request for resources to transmit the first type of report, and include an indication of the second type (MIMO BM) of measurement results;

Note: the WTRU may transmit a MAC CE if it obtained a grant. The WTRU may transmit SR if there is no available grant (legacy behavior). However, according to this embodiment, the WTRU uses the beam management report to indicate mobility event if there is an available resource to do so. The WTRU may also provide (report) the beam management results even if there is no event triggered for beam management.

The WTRU may include, in the second type (beam management) of report (a-c):
a) an indication of the first type of event (mobility event ID);
b) an indication of SR (for transmission of the MAC CE containing further results, possibly with the report size);
c) a measurement result for the first (mobility) event;
d) an indication may be one-bit indication in the first PUCCH channel (e.g., using mode A/B of BM reporting). In this case, this can be interpreted as SR for MAC CE transmission or allocation of second PUCCH resource;
e) WTRU may need to prioritize the report content. e.g.,, some or all of the mobility results may have higher priority than BM results for the serving cell. In this case, the report is modified to include the higher priority results (e.g., for supporting a cell switch).

In 305, receiving a scheduling grant for PUSCH based on the transmitted mobility event indication; and

In 306, transmitting a report, using MAC CE, containing the additional mobility measurement results.

Among the benefits of embodiments of the above method are, that it enables early indication of a mobility event, enabling gNB to prioritize or determine whether to performing beam management function or mobility, and enables to prioritize uplink scheduling e.g., gNB might wait for the MAC CE, or might trigger mobility or early sync procedures earlier based on the UCI indication.

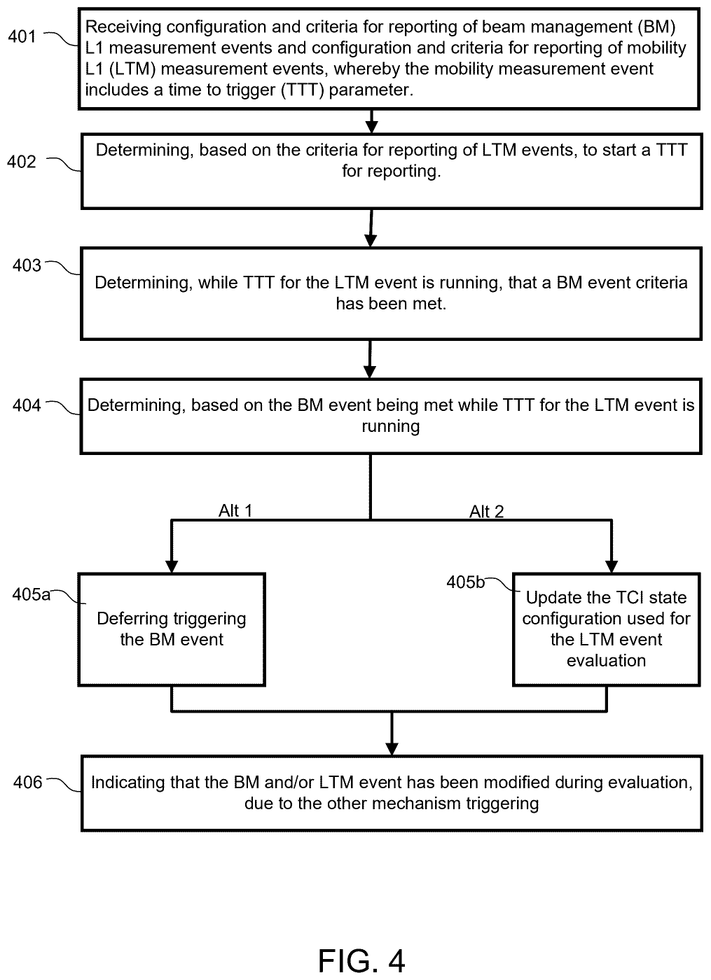

According to an embodiment, when two types of reporting are configured (e.g., both LTM L1 events using MAC CE, and MIMO beam management events using PUCCH), the outcome (e.g. event trigger) of one type affects the evaluation of the other type. E.g., MIMO BM event causes LTM event evaluation to be updated, for example to replace the serving cell beam based on the TCI state triggering the BM event. See FIG. 4.

In 401, receiving configuration and criteria for reporting of beam management (BM) L1 measurement events and configuration and criteria for reporting of mobility L1 (LTM) measurement events, whereby the mobility measurement event includes a time to trigger (TTT) parameter. This applies to event triggered reporting and conditional LTM cases.

In 402, determining, based on the criteria for reporting of LTM events, to start a TTT for reporting. E.g., event LTM4: Beam of candidate cell becomes better than absolute threshold.

In 403, determining, while TTT for the LTM event is running, that a BM event criteria has been met. E.g., trigger-Event2 (Quality of at least one new beam, such as L1-RSRP, becomes a threshold value better than the current beam).

In 404, determining, based on the BM event being met while TTT for the LTM event is running (a-b):
a) In 405a, according to a first embodiment (alternative 1), deferring triggering the BM event until TTT expires or is stopped;
b) In 405b, according to a second embodiment (alternative 2), updating the TCI state configuration used for the LTM event evaluation. Replacing serving cell beam considered: changing beam corresponding to the active TCI state to the beam corresponding to triggered BM event.

The first alternative embodiment versus the second alternative embodiment may be selected because (pre-) configured, or selected based on a criterion (e.g., remaining TTT, serving beam threshold, e.g., according to (based on) configuration)).

In 406, indicating, in the BM event reporting procedure, or in the MAC CE indicating LTM event, or in the handover completion (conditional LTM) message, depending which mechanism is used to report, that the BM and/or LTM event has been modified during evaluation, due to the other mechanism triggering (in this case there are two triggers-one for BM and another for LTM. This informs that one of the events has been modified (e.g., LTM) due to the other being triggered (e.g., BM))

Among the benefits, for example, is that the above enables coexistence of BM events and LTM events, without a BM event causing a mobility event to fail to trigger on time (because a change of serving cell beam implies resetting of mobility evaluation).

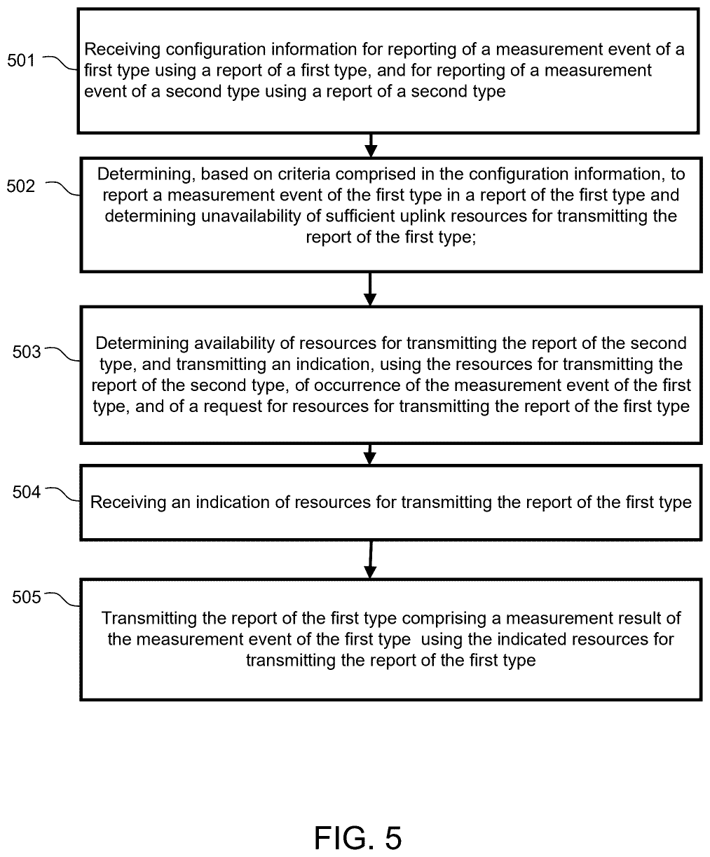

FIG. 5 is a flow chart of a method for reporting mobility measurement results according to an embodiment. The method is implemented by a wireless receive-transmit unit (WTRU) in a wireless communication network. The method may comprise:

In 501, receiving configuration information for reporting of a measurement event of a first type using a report of a first type, and for reporting of a measurement event of a second type using a report of a second type;

In 502, determining, based on criteria comprised in the configuration information, to report a measurement event of the first type in a report of the first type and determining unavailability of sufficient uplink resources for transmitting the report of the first type;

In 503, determining availability of resources for transmitting the report of the second type, and transmitting an indication, using the resources for transmitting the report of the second type, of occurrence of the measurement event of the first type, and of a request for resources for transmitting the report of the first type;

In 504, receiving an indication of resources for transmitting the report of the first type; and

In 505, transmitting the report of the first type comprising a measurement result of the measurement event of the first type using the indicated resources for transmitting the report of the first type.

According to an embodiment of the method, the measurement event of the first type is a lower-layer triggered mobility-layer 1 (LTM-L1) measurement event.

According to an embodiment of the method, the report of the first type is transmitted via a medium access control-control element (MAC-CE).

According to an embodiment of the method, the measurement event of the second type is a beam management measurement event.

According to an embodiment of the method, the report of the second type comprises multiple input multiple output beam management (MIMO BM) measurement results.

According to an embodiment of the method, the request for resources for transmitting the report of the first type comprises a scheduling request (SR).

According to an embodiment of the method, the report of the second type comprises at least one of:
an identifier of the measurement event of the first type;
an indication of a scheduling request (SR) for resources for transmission of the report of the first type; and
a measurement result of the measurement event of the first type.

There is also described and disclosed a wireless transmit-receive unit (WTRU) in a wireless communication network. The WTRU comprises at least one processor configured to:
receive configuration information for reporting of a measurement event of a first type using a report of a first type, and for reporting of a measurement event of a second type using a report of a second type;
determine, based on criteria comprised in the configuration information, to report a measurement event of the first type in a report of the first type and determining unavailability of sufficient uplink resources for transmitting the report of the first type;
determine availability of resources for transmitting the report of the second type, and transmit an indication, using the resources for transmitting the report of the second type, of occurrence of the measurement event of the first type, and of a request for resources for transmitting the report of the first type;
receive an indication of resources for transmitting the report of the first type; and
transmit the report of the first type comprising a measurement result of the measurement event of the first type using the indicated resources for transmitting the report of the first type.

According to an embodiment of the WTRU, the measurement event of the first type is a lower-layer triggered mobility-layer 1 (LTM-L1) measurement event.

According to an embodiment of the WTRU, the report of the first type is transmitted via a medium access control-control element (MAC-CE).

According to an embodiment of the WTRU, the measurement event of the second type is a beam management measurement event.

According to an embodiment of the WTRU, the report of the second type comprises multiple input multiple output beam management (MIMO BM) measurement results.

According to an embodiment of the WTRU, the request for resources for transmitting the report of the first type comprises a scheduling request (SR).

According to an embodiment of the WTRU, the report of the second type comprises at least one of:
an identifier of the measurement event of the first type;
an indication of a scheduling request (SR) for resources for transmission of the report
of the first type; and
a measurement result of the measurement event of the first type.

### Conclusion

Although features and elements are provided above in particular combinations, one of ordinary skill in the art will appreciate that each feature or element can be used alone or in any combination with the other features and elements. The present disclosure is not to be limited in terms of the particular embodiments described in this application, which are intended as illustrations of various aspects. Many modifications and variations may be made without departing from its spirit and scope, as will be apparent to those skilled in the art. No element, act, or instruction used in the description of the present application should be construed as critical or essential to the invention unless explicitly provided as such. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods or systems.

The foregoing embodiments are discussed, for simplicity, with regard to the terminology and structure of wireless communication capable devices, (e.g., radio wave emitters and receivers). However, the embodiments discussed are not limited to these systems but may be applied to other systems that use other forms of electromagnetic waves or non-electromagnetic waves such as acoustic waves.

It is also to be understood that the terminology used herein is for the purpose of describing particular embodiments only, and is not intended to be limiting. As used herein, the term “video” or the term “imagery” may mean any of a snapshot, single image and/or multiple images displayed over a time basis. As another example, when referred to herein, the terms “user equipment” and its abbreviation “UE”, the term “remote” and/or the terms “head mounted display” or its abbreviation “HMD” may mean or include (i) a wireless transmit and/or receive unit (WTRU); (ii) any of a number of embodiments of a WTRU; (iii) a wireless-capable and/or wired-capable (e.g., tetherable) device configured with, inter alia, some or all structures and functionality of a WTRU; (iii) a wireless-capable and/or wired-capable device configured with less than all structures and functionality of a WTRU; or (iv) the like. Details of an example WTRU, which may be representative of any WTRU recited herein, are provided herein with respect to FIGS. 1A-1D. As another example, various disclosed embodiments herein supra and infra are described as utilizing a head mounted display. Those skilled in the art will recognize that a device other than the head mounted display may be utilized and some or all of the disclosure and various disclosed embodiments can be modified accordingly without undue experimentation. Examples of such other device may include a drone or other device configured to stream information for providing the adapted reality experience.

In addition, the methods provided herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

Variations of the method, apparatus and system provided above are possible without departing from the scope of the invention. In view of the wide variety of embodiments that can be applied, it should be understood that the illustrated embodiments are examples only and should not be taken as limiting the scope of the following claims. For instance, the embodiments provided herein include handheld devices, which may include or be utilized with any appropriate voltage source, such as a battery and the like, providing any appropriate voltage.

Moreover, in the embodiments provided above, processing platforms, computing systems, controllers, and other devices that include processors are noted. These devices may include at least one Central Processing Unit (“CPU”) and memory. In accordance with the practices of persons skilled in the art of computer programming, reference to acts and symbolic representations of operations or instructions may be performed by the various CPUs and memories. Such acts and operations or instructions may be referred to as being “executed,” “computer executed” or “CPU executed.”

One of ordinary skill in the art will appreciate that the acts and symbolically represented operations or instructions include the manipulation of electrical signals by the CPU. An electrical system represents data bits that can cause a resulting transformation or reduction of the electrical signals and the maintenance of data bits at memory locations in a memory system to thereby reconfigure or otherwise alter the CPU's operation, as well as other processing of signals. The memory locations where data bits are maintained are physical locations that have particular electrical, magnetic, optical, or organic properties corresponding to or representative of the data bits. It should be understood that the embodiments are not limited to the above-mentioned platforms or CPUs and that other platforms and CPUs may support the provided methods.

The data bits may also be maintained on a computer readable medium including magnetic disks, optical disks, and any other volatile (e.g., Random Access Memory (RAM)) or non-volatile (e.g., Read-Only Memory (ROM)) mass storage system readable by the CPU. The computer readable medium may include cooperating or interconnected computer readable medium, which exist exclusively on the processing system or are distributed among multiple interconnected processing systems that may be local or remote to the processing system. It should be understood that the embodiments are not limited to the above-mentioned memories and that other platforms and memories may support the provided methods.

In an illustrative embodiment, any of the operations, processes, etc. described herein may be implemented as computer-readable instructions stored on a computer-readable medium. The computer-readable instructions may be executed by a processor of a mobile unit, a network element, and/or any other computing device.

There is little distinction left between hardware and software implementations of aspects of systems. The use of hardware or software is generally (but not always, in that in certain contexts the choice between hardware and software may become significant) a design choice representing cost versus efficiency tradeoffs. There may be various vehicles by which processes and/or systems and/or other technologies described herein may be effected (e.g., hardware, software, and/or firmware), and the preferred vehicle may vary with the context in which the processes and/or systems and/or other technologies are deployed. For example, if an implementer determines that speed and accuracy are paramount, the implementer may opt for a mainly hardware and/or firmware vehicle. If flexibility is paramount, the implementer may opt for a mainly software implementation. Alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples include one or more functions and/or operations, it will be understood by those within the art that each function and/or operation within such block diagrams, flowcharts, or examples may be implemented, individually and/or collectively, by a wide range of hardware, software, firmware, or virtually any combination thereof. In an embodiment, several portions of the subject matter described herein may be implemented via Application Specific Integrated Circuits (ASICs), Field Programmable Gate Arrays (FPGAs), digital signal processors (DSPs), and/or other integrated formats. However, those skilled in the art will recognize that some aspects of the embodiments disclosed herein, in whole or in part, may be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein may be distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a CD, a DVD, a digital tape, a computer memory, etc., and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein may be integrated into a data processing system via a reasonable amount of experimentation. Those having skill in the art will recognize that a typical data processing system may generally include one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity, control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components included within, or connected with, different other components. It is to be understood that such depicted architectures are merely examples, and that in fact many other architectures may be implemented which achieve the same functionality. In a conceptual sense, any arrangement of components to achieve the same functionality is effectively “associated” such that the desired functionality may be achieved. Hence, any two components herein combined to achieve a particular functionality may be seen as “associated with” each other such that the desired functionality is achieved, irrespective of architectures or intermedial components. Likewise, any two components so associated may also be viewed as being “operably connected”, or “operably coupled”, to each other to achieve the desired functionality, and any two components capable of being so associated may also be viewed as being “operably couplable” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, where only one item is intended, the term “single” or similar language may be used. As an aid to understanding, the following appended claims and/or the descriptions herein may include usage of the introductory phrases “at least one” and “one or more” to introduce claim recitations. However, the use of such phrases should not be construed to imply that the introduction of a claim recitation by the indefinite articles “a” or “an” limits any particular claim including such introduced claim recitation to embodiments including only one such recitation, even when the same claim includes the introductory phrases “one or more” or “at least one” and indefinite articles such as “a” or “an” (e.g., “a” and/or “an” should be interpreted to mean “at least one” or “one or more”). The same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, the terms “any of” followed by a listing of a plurality of items and/or a plurality of categories of items, as used herein, are intended to include “any of,” “any combination of,” “any multiple of,” and/or “any combination of multiples of” the items and/or the categories of items, individually or in conjunction with other items and/or other categories of items. Moreover, as used herein, the term “set” is intended to include any number of items, including zero. Additionally, as used herein, the term “number” is intended to include any number, including zero. And the term “multiple”, as used herein, is intended to be synonymous with “a plurality”.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein may be readily broken down into a lower third, middle third and upper third, etc. As will also be understood by one skilled in the art all language such as “up to,” “at least,” “greater than,” “less than,” and the like includes the number recited and refers to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

Moreover, the claims should not be read as limited to the provided order or elements unless stated to that effect. In addition, use of the terms “means for” in any claim is intended to invoke 35 U.S.C. § 112, ¶6 or means-plus-function claim format, and any claim without the terms “means for” is not so intended.

What is claimed is:

1. A method, implemented by a wireless receive-transmit unit (WTRU) in a wireless communication network, the method comprising:
receiving configuration information for reporting of a measurement event of a first type using a report of a first type, and for reporting of a measurement event of a second type using a report of a second type;
determining, based on criteria comprised in the configuration information, to report a measurement event of the first type in a report of the first type and determining unavailability of sufficient uplink resources for transmitting the report of the first type;
determining availability of resources for transmitting the report of the second type, and transmitting an indication, using the resources for transmitting the report of the second type, of occurrence of the measurement event of the first type, and of a request for resources for transmitting the report of the first type;
receiving an indication of resources for transmitting the report of the first type; and
transmitting the report of the first type comprising a measurement result of the measurement event of the first type using the indicated resources for transmitting the report of the first type.

2. The method of claim 1, wherein the measurement event of the first type is a lower-layer triggered mobility-layer 1 (LTM-L1) measurement event.

3. The method of claim 1, wherein the report of the first type is transmitted via a medium access control-control element (MAC-CE).

4. The method according to claim 1, wherein the measurement event of the second type is a beam management measurement event.

5. The method according to claim 1, wherein the report of the second type comprises multiple input multiple output beam management (MIMO BM) measurement results.

6. The method according to claim 1, wherein the request for resources for transmitting the report of the first type comprises a scheduling request (SR).

7. The method according to claim 1, wherein the report of the second type comprises at least one of:
an identifier of the measurement event of the first type;
an indication of a scheduling request (SR) for resources for transmission of the report of the first type; and
a measurement result of the measurement event of the first type.

8. A wireless transmit-receive unit (WTRU) in a wireless communication network, wherein the WTRU comprises at least one processor configured to:
receive configuration information for reporting of a measurement event of a first type using a report of a first type, and for reporting of a measurement event of a second type using a report of a second type;
determine, based on criteria comprised in the configuration information, to report a measurement event of the first type in a report of the first type and determining unavailability of sufficient uplink resources for transmitting the report of the first type;
determine availability of resources for transmitting the report of the second type, and transmit an indication, using the resources for transmitting the report of the second type, of occurrence of the measurement event of the first type, and of a request for resources for transmitting the report of the first type;
receive an indication of resources for transmitting the report of the first type; and
transmit the report of the first type comprising a measurement result of the measurement event of the first type using the indicated resources for transmitting the report of the first type.

9. The WTRU of claim 8, wherein the measurement event of the first type is a lower-layer triggered mobility-layer 1 (LTM-L1) measurement event.

10. The WTRU of claim 8, wherein the report of the first type is transmitted via a medium access control-control element (MAC-CE).

11. The WTRU according to claim 8, wherein the measurement event of the second type is a beam management measurement event.

12. The WTRU according to claim 8, wherein the report of the second type comprises multiple input multiple output beam management (MIMO BM) measurement results.

13. The WTRU according to claim 8, wherein the request for resources for transmitting the report of the first type comprises a scheduling request (SR).

14. The WTRU according to claim 8, wherein the report of the second type comprises at least one of:
an identifier of the measurement event of the first type;
an indication of a scheduling request (SR) for resources for transmission of the report of the first type; and
a measurement result of the measurement event of the first type.
